(19) United States
(12) Patent Application Publication
(10) Pub. No.: US 2007/0123170 A1
(43) Pub. Date: May 31, 2007

(54) Method and apparatus for interference mitigation for multi-radio systems in wireless networks

(76) Inventors: Sebnem Zorlu Ozer, Altamonte Springs, FL (US); Robert S. Greenway, Orlando, FL (US); Samer S. Hanna, Sanford, FL (US); William V. Hasty, Lake Forest, FL (US); Shyamal Ramachandran, Maitland, FL (US); Guenael J. Strutt, Sanford, FL (US); Surong Zeng, Altamonte Springs, FL (US); Heyun Zheng, Altamonte Springs, FL (US); Maximo J. Zorrilla, Longwood, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/289,808

(22) Filed: Nov. 30, 2005

(51) Int. Cl. H04B 15/00

(52) U.S. Cl. 455/63.1; 455/114.2

(57) ABSTRACT

A communication network (600) includes a first communication device (102-1) and at least one other communication device (102-3), wherein the first communication device (102-1) and the at least one other communication device (102-3) are proximately located. The communication network further includes a transaction detector (625) coupled between the first communication device (102-1) and the at least one other communication device (102-3) for detecting one or more transactions intended for each of the proximately located communication devices. The communication network (600) further includes a bandwidth allocator (610) adapted to impede communication activity for a predetermined time for the at least one other proximately located communication devices (102-3), and activate communication activity for the predetermined time for the first communication device (102-1) in response to the transaction detector (625) detecting a transaction intended for the first communication device (102-1).

### FIELD OF THE INVENTION

The present invention relates generally to wireless networks and specifically to a method and apparatus for interference mitigation for multi-radio systems in wireless networks.

### BACKGROUND

Communication networks are used to transmit digital data both through wires and through radio frequency links. Examples of communication networks are cellular telephone networks, messaging networks, and Internet networks. Such networks include land lines, radio links and satellite links, and can be used for such purposes as cellular telephone systems, Internet systems, and computer networks, messaging systems and other satellite systems, singularly or in combination.

In recent years, a type of mobile communications network known as an “ad-hoc” network has been developed. In this type of network, each mobile node is capable of operating as a base station or router for the other mobile nodes, thus eliminating the need for a fixed infrastructure of base stations. As can be appreciated by one skilled in the art, network nodes transmit and receive data packet communications in a multiplexed format, such as time-division multiple access (TDMA) format, code-division multiple access (CDMA) format, or frequency-division multiple access (FDMA) format.

More sophisticated ad-hoc networks are also being developed which, in addition to enabling mobile nodes to communicate with each other as in a conventional ad-hoc network, further enable the mobile nodes to access a fixed network and thus communicate with other mobile nodes, such as those on the public switched telephone network (PSTN), and on other networks such as the Internet.

When two or more communication devices within a wireless network are operating in the same frequency band in very close proximity, a pronounced near-far problem occurs. This problem is increased when the devices are co-located within the same enclosure. Printed circuit board separation in the enclosure does not provide enough isolation to mitigate the interference since the antennas are also in close proximity.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of an example communication network employing a system and method in accordance with an embodiment of the present invention.

FIG. 2 is a block diagram of an exemplary network having two co-located devices.

FIG. 3 illustrates channel contention within the network of FIG. 2.

FIG. 4 is a block diagram of an alternative exemplary network having two co-located devices.

FIG. 5 illustrates channel contention within the network of FIG. 4.

FIG. 6 is a block diagram of a radio architecture in accordance with an embodiment of the present invention.

FIG. 7 illustrates time coordination for the radio architecture of FIG. 6 in accordance with an embodiment of the present invention.

FIG. 8 illustrates the operation of an adaptive bandwidth allocator of the radio architecture of FIG. 6 in accordance with an embodiment of the present invention.

FIG. 9 is a block diagram of an example network architecture in accordance with an embodiment of the present invention.

FIG. 10 is an activity timing diagram of the network architecture of FIG. 9 in accordance with an embodiment of the present invention.

FIGS. 11-14 are operational flowcharts illustrating some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to interference mitigation for multi-radio systems in wireless networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of interference mitigation for multi-radio systems in wireless networks described herein. The non-processor circuits may include, but are not limited to, a radio receiver, a radio transmitter, signal drivers, clock circuits, power source circuits, and user input devices. As such, these functions may be interpreted as steps of a method to perform interference mitigation for multi-radio systems in wireless networks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A method and apparatus for interference mitigation for multi-radio systems in wireless networks is disclosed herein. The present invention solves interference problems associated with proximately located wireless communication devices by providing a distributed time coordination scheme among these proximately located wireless communication devices. Furthermore, time coordination is distributed in the local neighborhood to optimize the system performance for distributed ad-hoc networks.

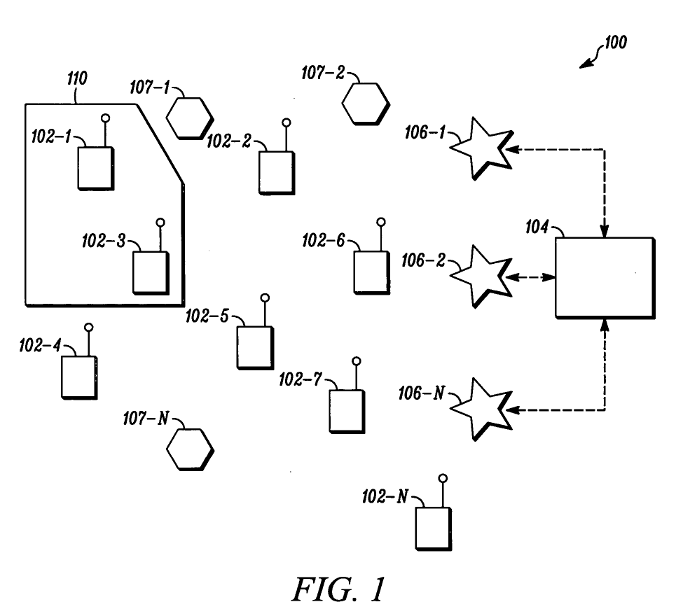

FIG. 1 is a block diagram illustrating an example of a communication network 100 employing an embodiment of the present invention. For illustration purposes, the communication network 100 comprises an adhoc wireless communications network. For example, the adhoc wireless communications network can be a mesh enabled architecture (MEA) network or an 802.11 network (i.e. 802.11a, 802.11b, or 802.11g) It will be appreciated by those of ordinary skill in the art that the communication network 100 in accordance with the present invention can alternatively comprise any packetized communication network. For example, the communication network 100 can be a network utilizing packet data protocols such as TDMA (time division multiple access), GPRS (General Packet Radio Service) and EGPRS (Enhanced GPRS).

As illustrated in FIG. 1, the communication network 100 includes a plurality of mobile nodes 102-1 through 102-n (referred to generally as nodes 102 or mobile nodes 102 or mobile communication devices 102), and can, but is not required to, include a fixed network 104 having a plurality of access points 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The communication network 100 further can include a plurality of fixed routers 107-1 through 107-n (referred to generally as nodes 107 or fixed routers 107 or fixed communication devices 107) for routing data packets between other nodes 102, 106 or 107. It is noted that for purposes of this discussion, the nodes discussed above can be collectively referred to as “nodes 102, 106 and 107”, or simply “nodes” or alternatively as “communication devices.”

As can be appreciated by one skilled in the art, the nodes 102, 106 and 107 are capable of communicating with each other directly, or via one or more other nodes 102, 106 or 107 operating as a router or routers for packets being sent between nodes. It will further be appreciated by those of ordinary skill in the art that one or more nodes 102, 106, and 107 can be proximately located with respect to each other. For example, as illustrated in FIG.1, two mobile nodes 102-1 and 102-3 can be co-located within a single enclosure 110. When two or more communication devices in the same enclosure are operating in the same frequency band in very close proximity, a pronounced near-far problem occurs. Board separation in the enclosure does not provide enough isolation to mitigate the interference since the antennas are also in close proximity. Similarly, when two or more nodes are proximately located such that interference is possible between the nodes, isolation can be physically difficult.

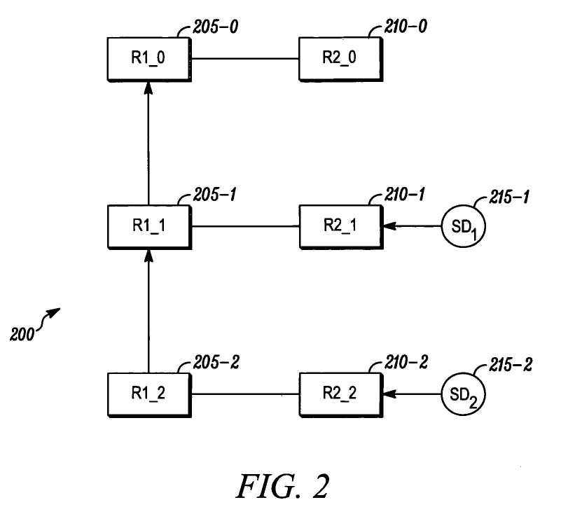

Referring to FIG. 2, an exemplary network 200 comprising two co-located devices is illustrated. The ideas presented herein can be also applied when more than two communication devices are co-located or when two or more communication devices are proximately located.

Within the network 200, two communication devices, R1_x (205-x) and R2_x (210-x) are co-located. For example, the two communication devices can be located within the same enclosed container or alternatively, the two communication devices can be located within close proximity to each other within the network 200.

It will be appreciated by those of ordinary skill in the art that, for example, the MAC protocols in the communication devices may be different (e.g. CSMA/CA, polling, TDMA). The basic ideas of the invention may be applied to any MAC protocol. However, the problem is more severe for contention based systems due to the lack of a central controller and predetermined channel allocation times. In the following, the invention is described with examples for contention based MAC protocols.

It will be appreciated by those of ordinary skill in the art that the two communication devices (205,210) can operate using one or more of a variety of network communication protocols. For example, the communication devices (205, 210) can operate on a mesh enabled architecture (MEA) network or an 802.11 network (i.e. 802.11a, 802.11b, or 802.11g). Alternatively, the communication devices can operate on a network utilizing packet data protocols such as TDMA (time division multiple access), GPRS (General Packet Radio Service) and EGPRS (Enhanced GPRS).

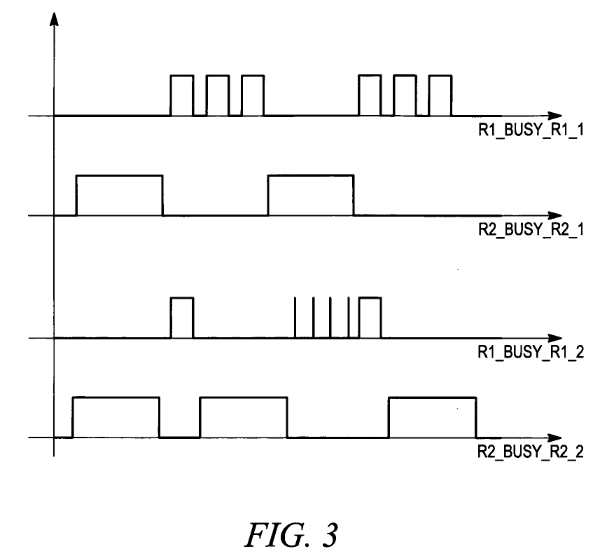

When two communication devices are located in close proximity to each other as illustrated, R1_1 (205-1) has to contend with traffic sent from R1_2 (210-2) and forwarded to the portal R1_0 (205-0), while not being able to transmit or receive when subscriber SD1 (215-1) is communicating with R2_1 (210-1). The subscriber may have one or more radios. In this example, it is assumed to have only R2 type radio. FIG. 3 illustrates how such a scenario would work when R1 (205) can preempt R2 (210). As can be understood by one skilled in the art, FIG. 3 shows a need for time coordination between nodes (see FIG. 5).

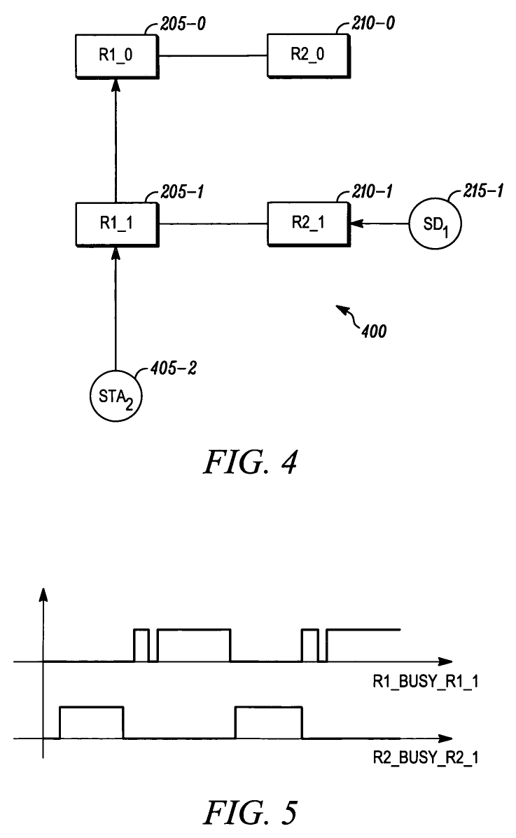

FIG. 4 illustrates an alternative exemplary network 400 in which the two communication devices (205-x, 210-x) are located in close proximity and communicating with SD1 (215-1) and STA2 (405-2). As illustrated in FIG. 4, communication contention is needed in this scenario also. FIG. 5 illustrates channel contention for the exemplary network 400. In this particular example, the station that is external to the infrastructure network is unable to distinguish between a collocated access point and a normal access point.

In the networks of FIGS. 2 and 4, the source nodes and the precursor nodes are unaware that the destination is unable to respond with a CTS, and packets may be lost. These lost packets may also cause out-of-order packet problems. In addition, any link quality measurement would be adversely affected by the absence of CTS response.

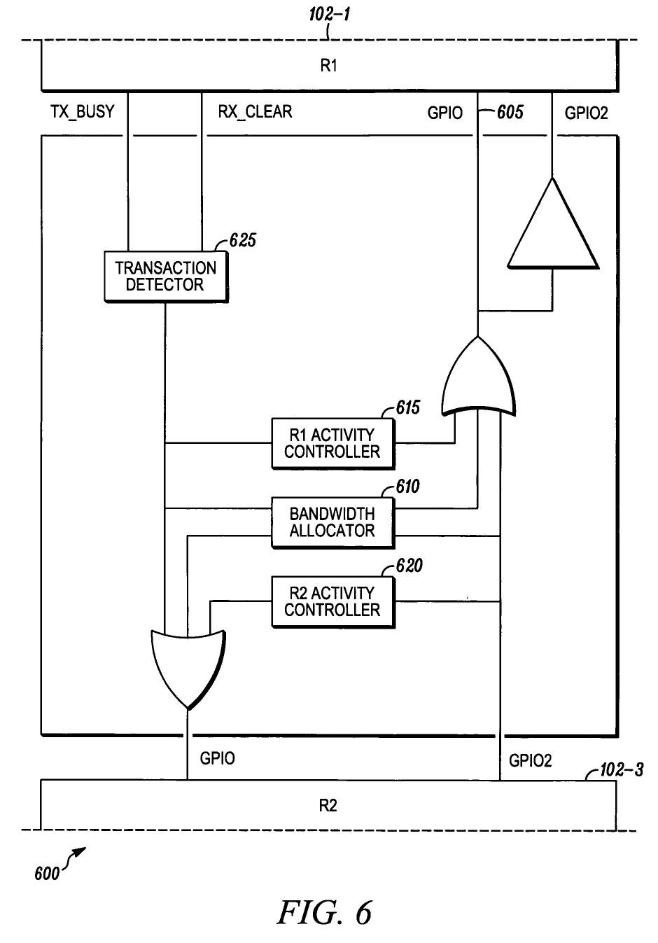

Referring to FIG. 6, a co-located radio architecture system 600 is illustrated in accordance with some embodiments of the present invention. The co-located radio architecture 600 of the present invention solves the interference problem by providing a distributed time coordination scheme among co-located radios (for example: 102-1,102-3 of FIG. 1). Furthermore, time coordination is distributed in the local neighborhood to optimize the system performance for distributed ad-hoc networks.

The solutions for informing co-located communication devices about transceiver activities (i.e. detected by a transaction detector 625) include low level interactions using Programmable Logic Devices (PLD) and passing low-level info from Media Access Controls (MAC) to MAC. The latter requires changing the MAC protocol and may have high delays.

Depending on the communication devices, an interrupt may be used to prevent the co-located communication device from transmitting; or a General Purpose Input Output (GPIO) 605 may be polled before each transmission to check the transceiver status of the co-located radio. A Bandwidth Allocator 610 analyzes bandwidth usage and shares airtime equitably. An activity controller (615,620) analyzes radio activities to allow for each radio (102-1, 102-3) to detect that a transmission is intended towards them within a reasonable amount of time.

The time coordination parameters may be adapted according to network conditions and traffic requirements. Furthermore, the traffic load information from precursor nodes and co-located radio may be used for longer term adaptation of the parameters. This is beneficial when the node that forwards traffic for a number of precursor nodes does not have complete information about the traffic destined for it.

The preemption times may be longer compared to a single transmission time. In the contention MAC case, the precursor nodes that are unaware that the next hop radio is preempted may send RTSs (Ready to Send Messages) without receiving CTSs (Clear To Send Messages). To overcome this problem, the co-located radio that is preempted sends a broadcast message to inform the preemption time. Similarly, it may advertise the other co-located communication devices' preemption time so that the precursor nodes will know the idle time for the next hop.

As illustrated in FIG. 6, on the R1 radio side, RX_CLEAR and TX_BUSY are used to create an R1_ACTIVE signal. R1_ACTIVE detects MAC transactions (i.e. RTS/CTS/DATA/ACK for 802.11 networks) and releases the line after a predetermined time. On the R2 side, a R2_ACTIVE signal is generated to prevent R1 from transmitting simultaneously. A Bandwidth Allocator analyzes R1_ACTIVE and R2_ACTIVE and shares airtime equitably. An activity controller analyzes R1_ACTIVE and R2_ACTIVE to allow for each radio to detect that a transmission is intended towards them within a reasonable amount of time.

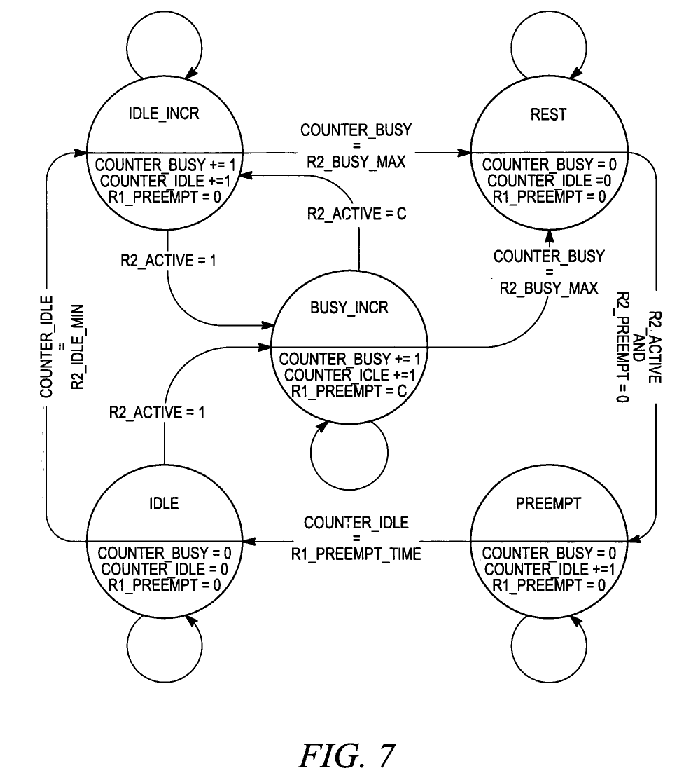

The PLD analyses R1_ACTIVE and R2_ACTIVE to determine if the airtime is shared fairly (may be based on radio weights) (see FIG. 7). The PLD verifies that R2_ACTIVE has a R2_BUSY_MIN-ms period of time where it is 0 every R2_IDLE_MAX ms. If not, R1_PREEMPT_ACT_CTRL is pulled high for a R2_PREEMPT_TIME ms period (the PLD waits for R2_ACTIVE to come down to 0 before it preempts R2). Similarly, it ensures that R1_ACTIVE has a R1_BUSY_MIN-ms period of time where it is 0 every R1_IDLE_MAX ms. If not, R2_PREEMPT_ACT_CTRL is pulled high for a R1_PREEMPT_TIME ms period (the PLD waits for R1_ACTIVE to come down to 0 before it preempts RI).

The time coordination parameters may be adapted according to network conditions and traffic requirements.

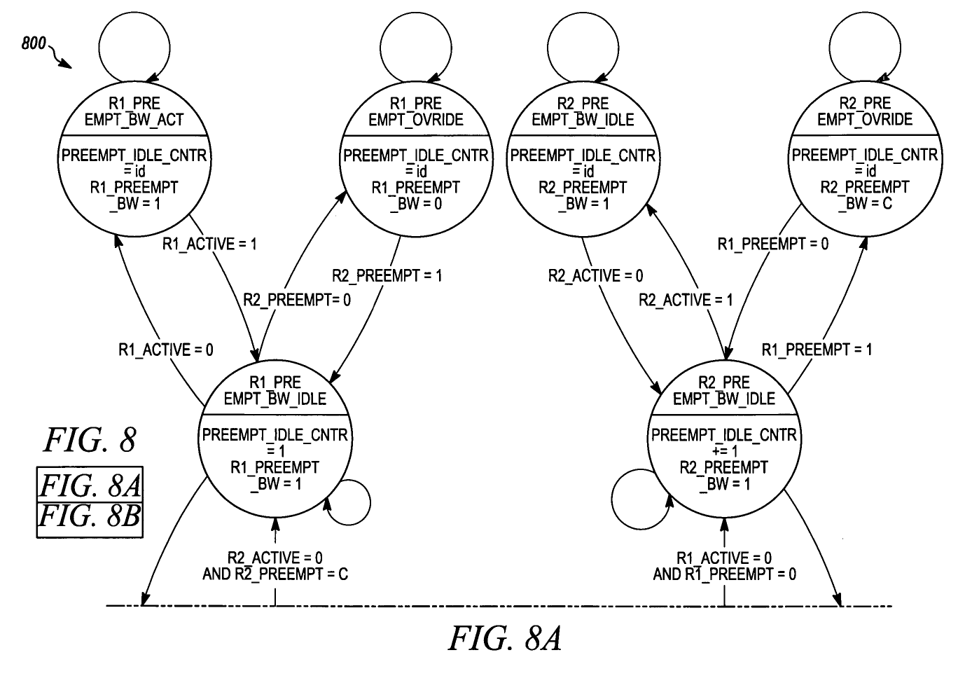

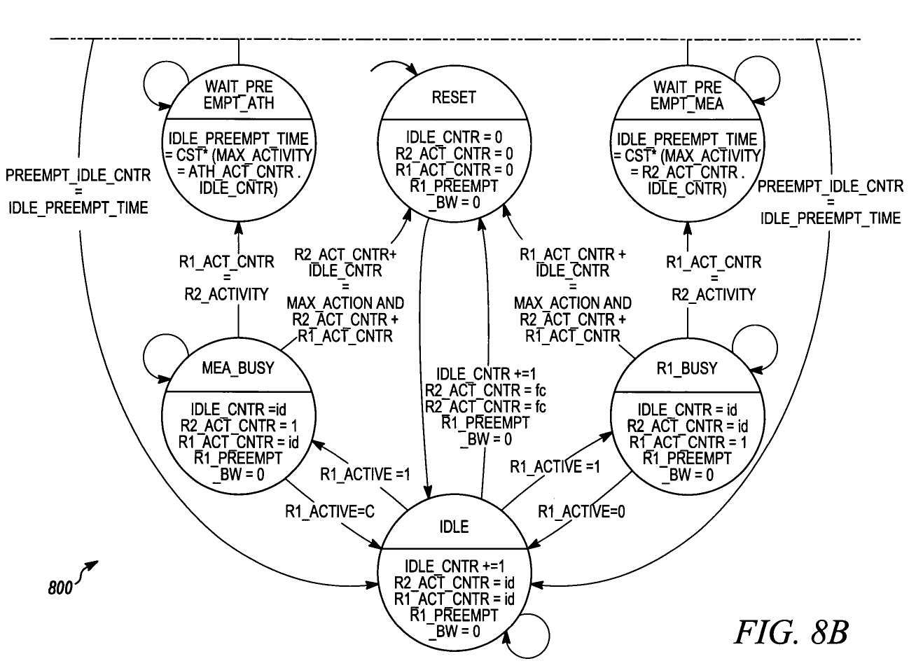

An adaptive bandwidth allocator 800 is displayed in FIG. 8. Furthermore, the traffic load information from precursor nodes and co-located radio may be used for longer term adaptation of the parameters. This is beneficial when the node that forwards traffic for a number of precursor nodes does not have complete information about the traffic destined for it. The bandwidth allocation may be done based on the traffic priority levels and requirements.

The preemption times may be longer compared to a single transmission time. In this case, the precursor nodes that are unaware that the next hop radio is preempted may send RTSs without receiving CTSs. This would waste the bandwidth, affect the link quality metric between the precursor node and next hop node and increase the backoff time for the precursor node. To overcome this problem, the co-located radio that is preempted sends a broadcast message (may be CTS-to-self, beacon, Hello etc.) to inform the preemption time. Similarly, it may advertise the other co-located radio's preemption time so that the precursor nodes will know the idle time for the next hop.

An Example Architecture

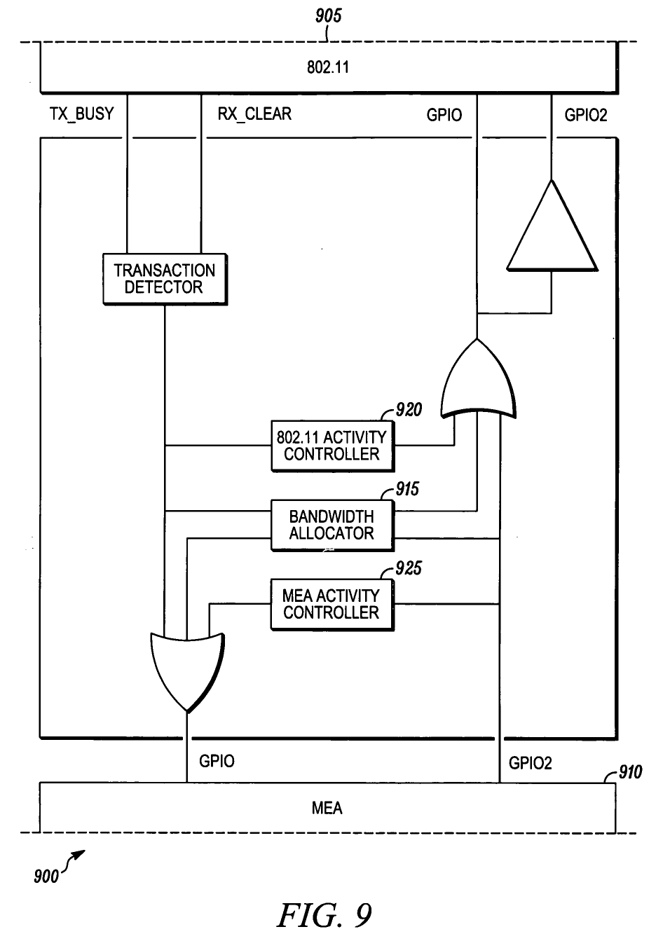

Referring to FIG. 9, an example is illustrated for a network architecture 900 consisting of 802.11 radios 905 and Mea (Mesh Enabled Architecture) co-located radios 910. The network consists of subscriber devices, wireless routers (WR) and intelligent access points (IAP) connected to the backbone. Each IAP and WR has both Mea and 802.11 transceivers offering 802.11/Mea front end and backhaul services. The two transceivers operate in the 4.9GHz band. The 802.1 la radio is retuned to operate in the 4.9GHz band. The communication between co-located radios is through a LAN Ethernet connection.

On the 802.11 side, RX_CLEAR and TX_BUSY are used to create an 802.11_ACTIVE signal. 802.11_ACTIVE detects 802.11 transactions (i.e. RTS/CTS/DATA/ACK) and releases the line after a predetermined time. On the MEA side, a MEA_ACTIVE signal is generated to prevent 802.11 radio from transmitting simultaneously. A Bandwidth Allocator 915 allows each node to obtain a fraction of airtime that it consistent with its needs. Traffic busy-ness is analyzed in the PLD and each radio is preempted according to channel utilization. An activity controller (920,925) analyzes 802.11_ACTIVE and MEA_ACTIVE to allow for each radio to detect that a transmission is intended towards them within a reasonable amount of time.

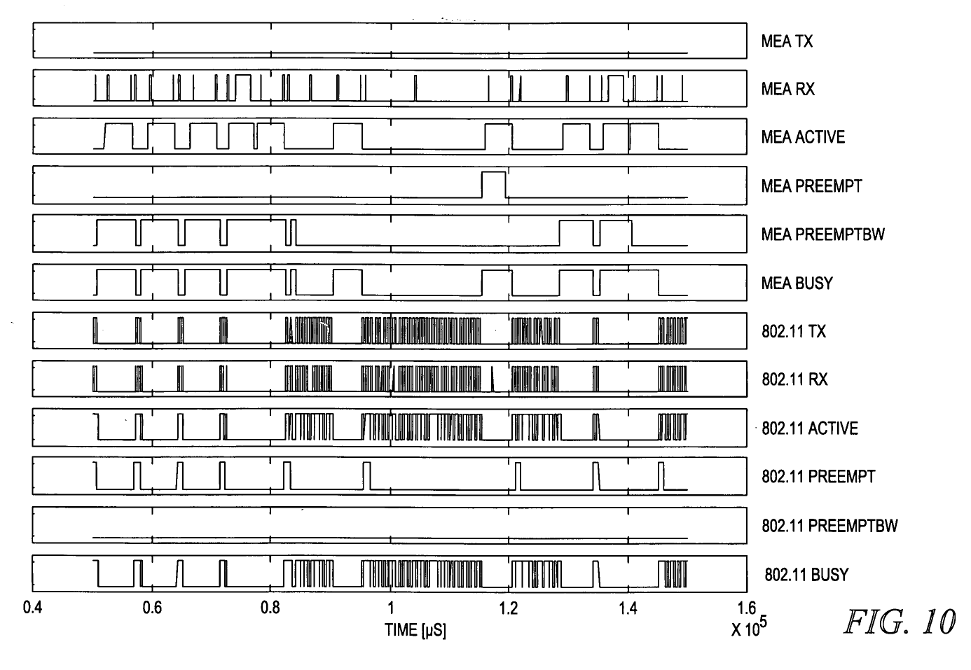

FIG. 10 displays a section of the activity timing diagram to demonstrate how the invention provides the time coordination between 802.11 radios 905 and Mea radios 910.

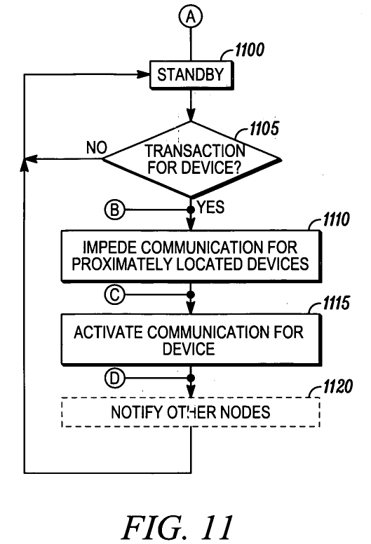

FIGS. 11-14 are operational flowcharts illustrating some embodiments of the present invention. Referring to FIG. 11, the process begins with node A and Step 1100 in which the network is in a standby condition. Next, in Step 1105, it is determined whether or not a transaction destined for a network device is detected. When no transaction is detected, the operation cycles back to Step 1100. When a transaction is detected (node B), the operation continues with Step 1110 in which communication activity for all devices proximately located to the device in which the transaction is intended is impeded. Next, (node C), the operation continues with Step 1115 in which communication activity is activated for the device in which the transaction is intended. Next, (node D), the operation optionally continues to Step 1120 in which all other nodes within the network are notified of the predetermined time for which the proximately located devices will be impeded from communication activity and the transaction related device will be communicatively active. The notification of Step 1120, for example, can include transmitting a broadcast message to one or more other nodes within the network informing of the predetermined time in which the proximately located device communication activity is impeded. The broadcast message, for example, can be transmitted from either the activated device or the impeded devices.

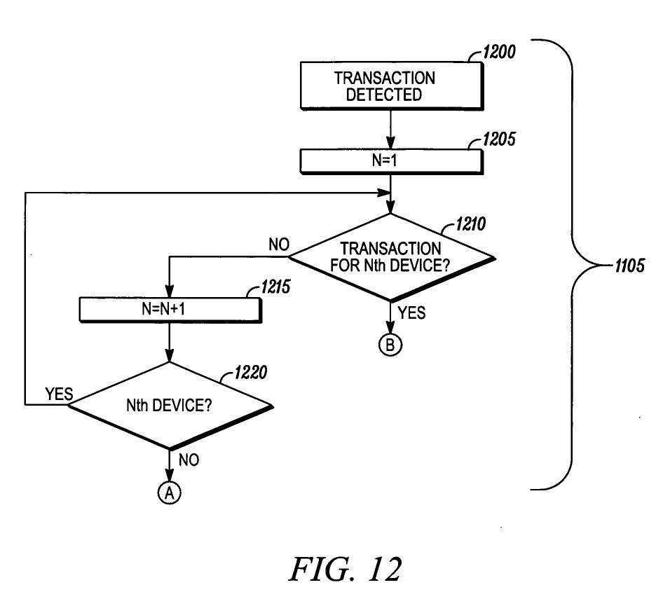

FIG. 12 illustrates more detail of the operation of FIG. 11. In particular, FIG. 12 illustrates more detail of the operation of Step 1105 in accordance with an embodiment of the present invention. Beginning with Step 1200, a transaction is detected. Next, in Step 1205, a parameter N is set to 1 (N=1). Next, in Step 1210, the operation determines whether the detected transaction is destined for the Nth device. When the transaction is destined for the Nth device, the operation continues to node B of FIG. 11. When the transaction is not destined for the Nth device, the operation continues to Step 1215 in which the parameter N is incremented (N=N+1). Next, in Step 1220, the operation determines whether an Nth device exists within the network. When no Nth device exists within the network, the operation cycles back to node A of FIG. 11. When an Nth device exists within the network, the operation cycles back to Step 1210.

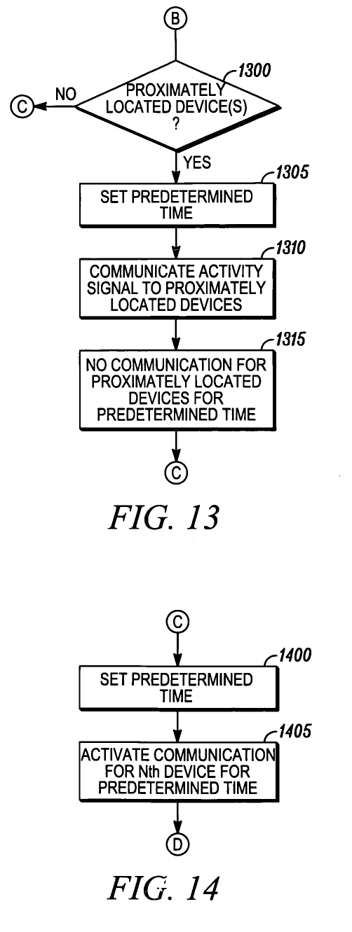

FIG. 13 illustrates more detail of the operation of FIG. 11. More particularly, FIG. 13 illustrates more detail of Step 1110 in accordance with an embodiment of the present invention. Beginning with node B, the operation continues with Step 1300 in which it is determined whether there are proximately located devices to the device in which the transaction is destined. When there are no proximately located devices, the operation continues to node C. When there are proximately located devices, the operation continues to Step 1305 in which a predetermined time is set. The predetermined time, for example, can be calculated using network conditions and traffic requirements. Alternatively, the predetermined time can be pre-programmed within the destination device, the proximately located devices, and/or the other nodes in the network. Alternatively, the predetermined time can be calculated using a comparison of device channel utilization requirements for the activated device and all the other proximately located devices. Next, in Step 1310, an activity signal is communicated to the proximately located devices. The activity signal, for example, can inform the proximately located devices that associated communication activity will be impeded. The activity signal, further, can inform the proximately located devices of the predetermined time. The activity signal can comprise one or more low level interactions using one or more programmable logic devices. For example, low level information can be passed from a media access control of the activated device to an associated media access control of each of the other proximately located devices. Next, in Step 1315, communication activity is impeded for the proximately located devices for the predetermined time. The oepration then continues with node C.

FIG. 14 illustrates further detail of the operation of FIG. 11. Specifically, FIG. 14 illustrates further detail of Step 1115 in accordance with an embodiment of the present invention. As illustrated, beginning with node C, at Step 1400, the predetermined time is set as described previously herein. Next, in Step 1405, communication activity is activated for the destination device (Nth device) for the predetermined time. The operation then continues with node D.

The advantage of this invention over other implementations is the fact that the traffic coordinator dynamically allocates enough bandwidth for the requirements of each collocated or proximately located radio station. This is especially beneficial if one radio is active and the other one is not: in that case, the one radio will occupy close to 100% of the airtime, thus operating as well as if the other radio was not present. Also, the invention is beneficial if both radios have disparate transmission rates: in this case, a fixed allocation of time between one radio and the other would severely slow down the fastest of both radios. Finally, the invention is beneficial if both radios have disparate traffic loads: the bandwidth allocator will ensure that each radio is given an amount of airtime that is commensurate to its own traffic load, thus sharing the bandwidth efficiently.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for coordination of communication activity within a network having at least two proximately located communication devices, the method comprising the steps of:
analyzing the communication activity of the at least two proximately located communication devices;
detecting an imbalance of communication activity between the at least two proximately located communication devices; and
impeding communication activity of one of the at least two proximately located communication device for a predetermined time.

2. A method for coordination of communication activity within a network as claimed in claim 1, further comprising the steps of:
detecting a transaction intended for a first communication device of the at least two proximately located communication devices;
impeding communication activity for the predetermined time for a second communication device of the at least two proximately located communication devices; and
activating communication activity for the predetermined time for the first communication device.

3. A method for coordination of communication activity within a network as claimed in claim 2, further comprising the step of:
transmitting a broadcast message to one or more other nodes within the network informing of the predetermined time in which the second communication device communication activity is impeded.

4. A method for coordination of communication activity as claimed in claim 3, wherein the transmitting step comprises transmitting the broadcast message from the first communication device.

5. A method for coordination of communication activity as claimed in claim 3, wherein the transmitting step comprises transmitting the broadcast message from the second communication device prior to the impeding step.

6. A method for coordination of communication activity as claimed in claim 1, wherein the predetermined time is calculated using network conditions and traffic requirements.

7. A method for coordination of communication activity as claimed in claim 1, wherein the predetermined time is calculated using a first channel utilization requirement for the first communication device and a second channel utilization requirement for the second communication device.

8. A method for coordination of communication activity within a network having at least two proximately located communication devices, the method comprising the steps of:
within a first communication device:
detecting a transaction intended for the first communication device,
communicating an activity signal to at least one other proximately located communication device, and
activating communication activity associated with the transaction; and
within the at least one other proximately located communication device:
receiving the activity signal sent from the first communication device; and
delaying communication activity for a predetermined time.

9. A method for coordination of communication activity as claimed in claim 8, wherein the activity signal includes the predetermined time.

10. A method for coordination of communication activity as claimed in claim 8, wherein the predetermined time is pre-programmed within the first communication device and the at least one other proximately located communication device.

11. A method for coordination of communication activity as claimed in claim 8, wherein the predetermined time is calculated using network conditions and traffic requirements.

12. A method for coordination of communication activity as claimed in claim 8, further comprising prior to the detecting step, the steps of:
within a bandwidth allocator:
periodically receiving a channel utilization requirement for each of the proximately located communication devices, and
calculating the predetermined time for the first communication device using a comparison of each of the channel utilization requirements received.

13. A method for coordination of communication activity as claimed in claim 8, further comprising within the first communication device prior to the communicating step:
sending an interrupt to the at least one other proximately located communication devices.

14. A method for coordination of communication activity as claimed in claim 8, further comprising within the first communication device prior to the communicating step:
polling each of the at least one other proximately located communication devices to check activity status.

15. A method for coordination of communication activity as claimed in claim 8, wherein the communicating the activity signal step comprises one or more low level interactions using one or more programmable logic devices.

16. A method for coordination of communication activity as claimed in claim 8, wherein the communicating the activity signal step comprises passing low level information from a first Media Access Control (MAC) of the first communication device to an associated Media Access Control (MAC) for each of the at least one other proximately located communication devices.

17. A communication network comprising:
a first communication device;
at least one other communication device, wherein the first communication device and the at least one other communication device are proximately located;
a transaction detector coupled between the first communication device and the at least one other communication device for detecting one or more transactions intended for each of the proximately located communication devices; and
a bandwidth allocator adapted to:
impede communication activity for a predetermined time for the at least one other proximately located communication devices, and
activate communication activity for the predetermined time for the first communication device in response to the transaction detector detecting a transaction intended for the first communication device.

18. A communication network as claimed in claim 17, further comprising:
one or more nodes communicatively coupled to the at least one other proximately located communication device,
wherein the at least one other proximately located communication device includes a transmitter for transmitting a broadcast message to the one or more other nodes informing of the predetermined time in which the communication activity for the at least one other proximately located communication device is impeded.

19. A communication network as claimed in claim 17, further comprising:
one or more nodes communicatively coupled to the at least one other proximately located communication device,
wherein the first communication device includes a transmitter for transmitting a broadcast message to the one or more other nodes informing of the predetermined time in which the communication activity for the at least one other proximately located communication device is impeded.

20. A communication network as claimed in claim 17, wherein the bandwidth allocator is further adapted to:
periodically receive a channel utilization requirement for each of the proximately located communication devices, and
calculating the predetermined time for the first communication device using a comparison of each of the channel utilization requirements received.

21. A communication network as claimed in claim 17, wherein each of the communication devices is a device selected from a group comprising a Mesh Enabled Architecture (MEA) device, an 802.11 device, a Bluetooth device, and a cellular device.
